(19) United States
(12) Patent Application Publication
(10) Pub. No.: US 2020/0343550 A1
(43) Pub. Date: Oct. 29, 2020

(54) POSITIVE ACTIVE MATERIAL FOR RECHARGEABLE LITHIUM BATTERY, METHOD OF PREPARING THE SAME, AND RECHARGEABLE LITHIUM BATTERY INCLUDING THE SAME

(71) Applicants: SAMSUNG SDI CO., LTD., Yongin-si (KR); Seoul National University R&DB Foundation, Seoul (KR)

(72) Inventors: Kwanghwan CHO, Yongin-si (KR); Kyu Tae LEE, Seoul (KR); Hanseul KIM, Seoul (KR); Sung Wook DOO, Seoul (KR); Seongmin KIM, Yangsan-si (KR)

(21) Appl. No.: 16/858,429

(22) Filed: Apr. 24, 2020

(30) Foreign Application Priority Data
Apr. 26, 2019 (KR) 10-2019-0049393
May 17, 2019 (KR) 10-2019-0058373
Mar. 31, 2020 (KR) 10-2020-0039300

(51) Int. Cl. H01M 4/525; H01M 4/505; H01M 4/131; H01M 4/36; H01M 4/134; H01M 4/04; H01M 10/0525

(52) U.S. Cl. CPC H01M 4/525; H01M 4/505; H01M 4/131; H01M 2004/028; H01M 4/134; H01M 4/0471; H01M 10/0525; H01M 4/366

(57) ABSTRACT

A positive active material for a rechargeable lithium battery includes a nickel-based lithium metal oxide having a layered crystal structure, and a coating layer including a lithium-metal oxide disposed selectively disposed on (003) crystalline plane of the nickel-based lithium metal oxide, wherein the positive active material includes at least one secondary particle including an agglomerate of two or more primary particles.

### CROSS-REFERENCE TO RELATED APPLICATION

This application claims priority to and the benefit of Korean Patent Application No. 10-2019-0049393 filed in the Korean Intellectual Property Office on Apr. 26, 2019, Korean Patent Application No. 10-2019-0058373 filed in the Korean Intellectual Property Office on May 17, 2019, and Korean Patent Application No. 10-2020-0039300 filed in the Korean Intellectual Property Office on Mar. 31, 2020, the entire content of each of which is incorporated herein by reference.

### BACKGROUND

### 1. Field

One or more embodiments of the present invention relate to a positive active material for a rechargeable lithium battery, a method of preparing the same, and a rechargeable lithium battery including the same.

### 2. Description of the Related Art

Rechargeable lithium batteries are used in a variety of applications because they have a high voltage and a high energy density. For example, electric vehicles utilize lithium rechargeable batteries having improved discharge capacity and life-span characteristics because they can operate at high temperatures, should charge and/or discharge large amounts of electricity, and should be used for a long time.

As a positive active material for lithium rechargeable batteries, nickel-based lithium metal oxide has been widely used as a positive active material due to improved capacity characteristics. However, the nickel-based lithium metal oxide may exhibit deteriorated cell characteristics due to side-reaction with an electrolyte solution, and thus improvement therefore is desirable.

### SUMMARY

An embodiment of the present disclosure provides a positive active material that easily intercalates/deintercalates lithium ions and provides improved power output characteristics.

Another embodiment provides a method of preparing the positive active material.

Another embodiment provides a rechargeable lithium battery having improved power output characteristics by employing a positive electrode including the positive active material.

An embodiment provides a positive active material for a rechargeable lithium battery including a nickel-based lithium metal oxide having a layered crystal structure, and a coating layer including a lithium-metal oxide selectively disposed on (003) crystalline plane of the nickel-based lithium metal oxide, wherein the positive active material includes at least one secondary particle including an agglomerate of two or more primary particles.

The lithium-metal oxide may have a monoclinic crystal system having a C2/c space group crystal structure.

A lattice mismatch ratio between a (003) plane of the nickel-based lithium metal oxide and a (00l) plane (where l is 1, 2, or 3) of the lithium-metal oxide may be less than or equal to about 15%.

The lithium-metal oxide may include a compound represented by Chemical Formula 1, a compound represented by Chemical Formula 2, or a combination thereof.

Li₂MO₃ Chemical Formula 1

Li₈MO₆. Chemical Formula 2

In Chemical Formula 1 and Chemical Formula 2,

M is a metal having an oxidation number of 4.

The lithium-metal oxide may include Li₂SnO₃, Li₂ZrO₃, Li₂TeO₃, Li₂RuO₃, Li₂TiO₃, Li₂MnO₃, Li₂PbO₃, Li₂HfO₃, Li₈SnO₆, Li₈ZrO₆, Li₈TeO₆, Li₈RuO₆, Li₈TiO₆, Li₈MnO₆, Li₈PbO₆, Li₈HfO₆, or a combination thereof.

A content of the lithium-metal oxide may be about 0.1 mol % to about 5 mol % based on a total amount of the nickel-based lithium metal oxide and the lithium-metal oxide.

The coating layer may have a thickness of about 1 nm to about 100 nm.

The lithium-metal oxide selectively disposed on the (003) crystalline plane of the nickel-based lithium metal oxide and the nickel-based lithium metal oxide may each have a layered structure that is epitaxially grown in a same c-axis direction.

The nickel-based lithium metal oxide may include a compound represented by Chemical Formula 3, a compound represented by Chemical Formula 4, or a combination thereof.

LiₐNiₓCo_{y}Q¹_{1-x-y}O₂. Chemical Formula 3

In Chemical Formula 3,

0.9≤a≤1.05, 0.6≤x≤0.98, 0.01≤y≤0.40, and Q¹ is at least one metal element selected from Mn, Al, Cr, Fe, V, Mg, Nb, Mo, W, Cu, Zn, Ga, In, La, Ce, Sn, Zr, Te, Ru, Ti, Pb, and Hf.

LiₐNiₓQ²₁₋ₓO₂. Chemical Formula 4

In Chemical Formula 4,

0.9≤a≤1.05, 0.6≤x≤1.0, and Q² is at least one metal element selected from Mn, Al, Cr, Fe, V, Mg, Nb, Mo, W, Cu, Zn, Ga, In, La, Ce, Sn, Zr, Te, Ru, Ti, Pb, and Hf.

The primary particles may have a particle diameter of about 100 nm to about 5 μm. The secondary particle may include at least one of a small particle diameter secondary particle having a particle diameter of greater than or equal to about 5 μm and less than about 8 μm and a large particle diameter secondary particle having a particle diameter of greater than or equal to about 8 μm and less than or equal to about 20 μm.

The primary particles may have a particle diameter of about 500 nm to about 3 μm.

The secondary particle may include at least one of a small particle diameter secondary particle having a particle diameter of greater than or equal to about 5 μm and less than about 6 μm and a large particle diameter secondary particle having a particle diameter of greater than or equal to about 10 μm and less than or equal to about 20 μm.

Another embodiment provides a method of preparing a positive active material for a rechargeable lithium battery that includes

mixing a first precursor for forming lithium-metal (M) oxide and a second precursor for forming nickel-based lithium metal oxide having a layered crystal structure with a solvent to obtain a precursor composition,

adding a surfactant to the precursor composition,

first heat-treating the resultant in a sealed state, and drying to produce a positive active material precursor, and

mixing the positive active material precursor with a lithium precursor followed by second heat-treating to produce the positive active material.

The first heat-treating may be performed at a temperature in a range of about 150° C. to about 550° C.

The second heat-treating may be performed at a temperature in a range of about 600° C. to about 950° C.

The second heat-treating may be performed at a temperature-increasing rate of less than or equal to about 5° C./min.

The method may further include cooling after the second heat-treating, and the cooling may be performed at a cooling rate of less than or equal to about 1° C./min.

The method may further include additional heat-treating after the second heat-treating.

The first precursor may include a metal (M)-containing halide, a metal (M)-containing sulfate, a metal (M)-containing hydroxide, a metal (M)-containing nitrate, a metal (M)-containing carboxylate, a metal (M)-containing oxalate, or a combination thereof.

The second precursor may include at least one nickel precursor selected from Ni(OH)₂, NiO, NiOOH, NiCO₃.2Ni(OH)₂.4H₂O, NiC₂O₄.2H₂O, Ni(NO₃)₂.6H₂O, NiSO₄, NiSO₄.6H₂O, a nickel fatty acid salt, and a nickel halide.

The lithium precursor may include a lithium hydroxide, a lithium nitrate, a lithium carbonate, a lithium acetate, a lithium sulfate, a lithium chloride, a lithium fluoride, or a mixture thereof.

Another embodiment provides a rechargeable lithium battery including the positive active material.

The positive active material includes a coating layer formed only on (e.g., formed substantially parallel only to) the (003) crystalline plane in a c-axis direction, so that the charge transfer resistance does not increase compared with the positive active material including a coating layer formed on the crystalline plane in a-axis and b-axis directions, resulting in providing a rechargeable lithium battery having improved power output characteristics.

In addition, the positive active material has high voltage characteristics, and by adopting such a positive active material, a positive electrode for a rechargeable lithium battery having improved positive electrode slurry stability and active mass density of an electrode plate during electrode manufacturing process may be fabricated. By adopting the positive active material, it is possible to fabricate a rechargeable lithium battery that exhibits reduced gas generation at a high voltage, and improved reliability and safety.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a perspective view schematically showing a representative structure of a rechargeable lithium battery according to an embodiment.

FIG. 2 shows the X-ray diffraction analysis (XRD) results of the positive active materials according to Synthesis Example 1, Synthesis Example 2, and Comparative Synthesis Example 1.

FIGS. 3A-3D show a STEM-EDS (scanning transmission electron microscopy-energy dispersive X-ray spectroscopy) analysis result of the positive active material according to Synthesis Example 1.

FIG. 4 shows an EDS-line profile analysis result of the positive active material according to Synthesis Example 1.

FIG. 5A is a HAADF (scanning transmission electron microscope-high-angle annular dark field) image result in which the interface between Li[Ni_{0.80}Co_{0.15}Al_{0.05}]O₂—Li₂SnO₃ of the positive active material according to Synthesis Example 1 is expanded to atomic resolution.

FIG. 5B is a TEM image showing enlarged atom arrangement of the interface of Li[Ni_{0.80}Co_{0.15}Al_{0.05}]O₂ and Li₂SnO₃ coating layers in the STEM analysis of positive active material according to Synthesis Example 1.

### DETAILED DESCRIPTION

Hereinafter, further detailed descriptions will be given of a rechargeable lithium battery including a positive active material for a rechargeable lithium battery according to an embodiment, of a positive electrode including the positive active material, and of a manufacturing method thereof. However, these are example embodiments, the present disclosure is not limited thereto, and the subject matter of the present disclosure is defined by the scope of the appended claims, and equivalents thereof.

As used herein, the term “particle diameter” refers to an average particle diameter (D50) which is a median value in a particle size distribution, as determined using a particle size analyzer. In some embodiments, the “particle diameter” refers to the average value of the longest length or dimension of the particle which is not spherical particle.

A positive active material for a rechargeable lithium battery according to an embodiment includes a nickel-based lithium metal oxide having a layered crystal structure, and a coating layer including a lithium-metal oxide selectively disposed on (003) crystalline plane of the nickel-based lithium metal oxide, wherein the positive active material includes at least one secondary particle including an agglomerate of two or more primary particles.

In order to improve electrochemical characteristics of the nickel-based lithium metal oxide, a method of coating a metal oxide-based or phosphate-based material on the surface thereof has been performed. However, when this method is performed, the metal oxide-based or phosphate-based material is non-selectively coated on the whole surface of the nickel-based lithium metal oxide. As a result, charge transfer resistance of the metal oxide-based or phosphate-based material may be increased, and thus power output characteristics of a rechargeable lithium battery including a positive electrode using the same may be deteriorated.

In order to solve the aforementioned problem, the positive active material according to embodiments of the present disclosure may effectively (or suitably) suppress (or reduce) the charge transfer resistance increase without generally (or substantially) interfering with lithium intercalation and deintercalation due to the surface coating of the nickel-based lithium metal oxide by forming a coating layer selectively, e.g., by including a lithium-metal oxide not on a crystalline plane where lithium ions are intercalated/deintercalated, but on the other (003) crystalline plane of the nickel-based lithium metal oxide.

In the positive active material of the present embodiments, the coating layer including the lithium-metal oxide is selectively disposed on a plane where lithium ions are not intercalated and deintercalated, that is, the (003) crystalline plane of the nickel-based lithium metal oxide.

The lithium-metal oxide may have a C2/c space group crystal structure of a monoclinic crystal system. When the lithium-metal oxide has this crystal structure, a lattice mismatch on the interface thereof with the nickel-based lithium metal oxide having a layered crystal structure may be minimized or reduced.

For example, the lattice mismatch of the (003) plane of the nickel-based lithium metal oxide and a (00l) plane (l is 1, 2, or 3) of the lithium-metal oxide may have a ratio of less than or equal to about 15%, for example, less than or equal to about 13%, less than or equal to about 12%, less than or equal to about 11%, less than or equal to about 10%, less than or equal to about 9%, less than or equal to about 8%, less than or equal to about 7%, less than or equal to about 6%, less than or equal to about 5%, less than or equal to about 4%, or less than or equal to about 3%. When the lattice mismatch has the ratio within the range described herein, the (003) plane of a Li—O octahedron structure of the nickel-based lithium metal oxide and the (00l) plane (l is 1, 2, or 3) of a Li—O octahedron structure of the lithium-metal oxide may be well shared with each other, and the coating layer including the lithium-metal oxide may not be separated on the interface, but may be stably (or suitably) present.

The lattice mismatch ratio (%) may be calculated using Equation 1:

|A-B|/B×100. Equation 1

In Equation 1, A indicates an oxygen-oxygen bond length of the (003) plane of the nickel-based lithium metal oxide, and B indicates an oxygen-oxygen bond length of the (00l) plane (l is 1, 2, or 3) of the lithium-metal oxide.

In an embodiment, when the nickel-based lithium metal oxide is LiNiO₂, and the lithium-metal (M) oxide is Li₂MO₃ of Chemical Formula 1 or Li₈MO₆ of Chemical Formula 2, the lattice mismatch ratio is the same as shown in Table 1. The oxygen-oxygen bond length of the (003) plane of LiNiO₂ is about 2.875 Å.

TABLE 1

| | Oxygen-oxygen | |
|---|---|---|
| | bond length of | |
| | (00l) plane of | Lattice |
| Lithium-metal | lithium-metal | mismatch |
| (M) oxide | (M) oxide (Å) | ratio (%) |

| | | | |
|---|---|---|---|
| Li₂MO₃ | Sn⁴⁺ | 3.057 | 5.95 |
| | Zr⁴⁺ | 3.171 | 9.33 |
| | Te⁴⁺ | 3.241 | 11.29 |
| | Ru⁴⁺ | 2.888 | 0.45 |
| | Ti⁴⁺ | 2.926 | 1.74 |
| | Pb⁴⁺ | 3.028 | 5.05 |
| | Hf⁴⁺ | 3.151 | 8.76 |
| Li₈MO₆ | Sn⁴⁺ | 3.271 | 12.11 |
| | Zr⁴⁺ | 3.316 | 13.30 |
| | Ti⁴⁺ | 3.338 | 13.87 |
| | Pb⁴⁺ | 3.356 | 14.33 |
| | Hf⁴⁺ | 3.324 | 13.51 |

Table 1 shows that the lithium-metal oxides, such as Li₂MO₃ and Li₈MO₆, have a lattice mismatch ratio of less than or equal to 15%, indicating that these lithium-metal oxides may be coated on the (003) plane of the layered nickel-based lithium metal oxide of LiNiO₂.

The lithium-metal oxide may include a compound represented by Chemical Formula 1, a compound represented by Chemical Formula 2, or a combination thereof.

Li₂MO₃ Chemical Formula 1

Li₈MO₆. Chemical Formula 2

In Chemical Formulae 1 and 2, M is a metal having an oxidation number of 4.

The lithium-metal oxide may include Li₂SnO₃, Li₂ZrO₃, Li₂TeO₃, Li₂RuO₃, Li₂TiO₃, Li₂MnO₃, Li₂PbO₃, Li₂HfO₃, Li₈SnO₆, Li₈ZrO₆, Li₈TeO₆, Li₈RuO₆, Li₈TiO₆, Li₈MnO₆, Li₈PbO₆, Li₈HfO₆, and/or a combination thereof.

An amount of the lithium-metal oxide may be less than or equal to about 5 mol %, for example, greater than or equal to about 0.1 mol %, greater than or equal to about 0.2 mol %, greater than or equal to about 0.5 mol %, greater than or equal to about 1 mol %, greater than or equal to about 1.5 mol %, or greater than or equal to about 2 mol % and less than or equal to about 5 mol %, less than or equal to about 4.5 mol %, less than or equal to about 4 mol %, or less than or equal to about 3 mol % based on a total amount of the nickel-based lithium metal oxide and the lithium-metal oxide. When the amount of the lithium-metal oxide is within the range described herein, the coating layer on the (003) plane of the nickel-based lithium metal oxide may effectively (or suitably) suppress (or reduce) an increase of the charge transfer resistance.

The positive active material according to an embodiment has a structure that the coating layer including the lithium-metal oxide is stacked on one plane of the nickel-based lithium metal oxide. The coating layer may be selectively disposed on the (003) crystalline plane of the nickel-based lithium metal oxide.

The coating layer may have a thickness in a range of about 1 nm to about 100 nm, for example, about 1 nm to about 80 nm, for example, about 1 nm to about 70 nm, for example, about 1 nm to about 60 nm, for example, about 1 nm to about 50 nm, for example, about 10 nm to about 100 nm, for example, about 20 nm to about 100 nm, for example, about 30 nm to about 100 nm, or, for example, about 40 nm to about 100 nm. When the coating layer has a thickness within any of these ranges, the charge transfer resistance of the nickel-based lithium metal oxide may be effectively (or suitably) blocked (or protected) from being increased due to the coating.

The coating layer may be a continuous or discontinuous film.

In the positive active material according to an embodiment, the lithium-metal oxide selectively disposed on the (003) crystalline plane of the nickel-based lithium metal oxide and the nickel-based lithium metal oxide may each have an epitaxially grown layered structure in a same c-axis direction. As used herein, the terms “c-axis direction,” “a-axis direction,” and “b-axis direction” may each independently refer to a direction along an axis of symmetry of the respective space group, where the c-axis is the major axis of symmetry. For example, the c-axis direction may refer to the direction along the C2 axis of the C2/c space group of the lithium-metal oxide and/or the major axis of symmetry of the space group of the nickel-based lithium metal oxide (e.g., the R3m space group). The c-axis direction of the lithium-metal oxide and the nickel-based lithium metal oxide may be the same or substantially the same. Here, the epitaxially grown layered structure in the c-axis direction may be confirmed by using a TEM (transmission electron microscope) image and a FFT (fast fourier transformation) pattern of the TEM image.

The nickel-based lithium metal oxide coated with the coating layer of the present embodiments may have a layered crystal structure. The nickel-based lithium metal oxide having such a layered crystal structure may include a compound represented by Chemical Formula 3, a compound represented by Chemical Formula 4, or a combination thereof.

LiₐNiₓCo_{y}Q¹_{1-x-y}O₂. Chemical Formula 3

In Chemical Formula 3,

0.9≤a≤1.05, 0.6≤x≤0.98, 0.01≤y≤0.40, and Q¹ is at least one metal element selected from Mn, Al, Cr, Fe, V, Mg, Nb, Mo, W, Cu, Zn, Ga, In, La, Ce, Sn, Zr, Te, Ru, Ti, Pb, and Hf.

LiₐNiₓQ²₁₋ₓO₂. Chemical Formula 4

In Chemical Formula 4,

0.9≤a≤1.05, 0.6≤x≤1.0, and Q² is at least one metal element selected from Mn, Al, Cr, Fe, V, Mg, Nb, Mo, W, Cu, Zn, Ga, In, La, Ce, Sn, Zr, Te, Ru, Ti, Pb, and Hf.

The nickel-based lithium metal oxide may be a nickel-based lithium transition metal oxide when the compound includes a transition metal.

In an embodiment, the nickel-based lithium metal oxide may further include at least one element selected from calcium (Ca), strontium (Sr), boron (B), and fluorine (F). If the positive electrode is fabricated using the nickel-based lithium metal oxide that further includes these elements, electrochemical characteristics of the rechargeable lithium battery may be further improved. A content of the element(s) may be about 0.001 mol to about 0.1 mol relative to 1 mol of the metals.

The nickel-based lithium metal oxide may have a layered structure such as that of α-NaFeO₂, in which NiₓCo_{y}Q¹_{1-x-y}O₂ or NiₓQ²₁₋ₓO₂ and a Li layer are successively intersected, and may have an R-3m space group (e.g., the R3m space group). The space groups described herein have the same meaning as commonly understood in the art to which this disclosure pertains, and may be referred to utilizing, e.g., the short name (e.g., the international short symbol).

In an embodiment, sizes of primary particles and secondary particles of the positive active material may be adjusted to reduce a gas generation amount at a high voltage and secure reliability and safety during manufacture of a rechargeable lithium battery using the same.

In the positive active material, the primary particles may have a particle diameter of, for example, greater than or equal to about 100 nm, greater than or equal to about 200 nm, greater than or equal to about 300 nm, greater than or equal to about 400 nm, greater than or equal to about 500 nm, greater than or equal to about 600 nm, greater than or equal to about 700 nm, greater than or equal to about 800 nm, greater than or equal to about 900 nm, greater than or equal to about 1 μm, greater than or equal to about 1.5 μm, greater than or equal to about 2 μm, or greater than or equal to about 2.5 μm and less than or equal to about 5 μm, less than or equal to about 4.5 μm, less than or equal to about 4 μm, less than or equal to about 3.5 μm, or less than or equal to about 3 μm.

As for the secondary particles, small secondary particles may have a particle diameter of, for example, greater than or equal to about 5 μm and less than about 8 μm, or greater than or equal to about 5 μm and less than or equal to about 7.5 μm, or greater than or equal to about 5 μm and less than or equal to about 7 μm, or greater than or equal to about 5 μm and less than or equal to about 6.5 μm, or greater than or equal to about 5 μm and less than or equal to about 6 μm,

The large secondary particles may have a particle diameter of, for example, greater than or equal to about 8 μm and less than or equal to about 20 μm, or greater than or equal to about 8 μm and less than or equal to about 18 μm, or greater than or equal to about 8 μm and less than or equal to about 16 μm, or greater than or equal to about 10 μm and less than or equal to about 20 μm, or greater than or equal to about 12 μm and less than or equal to about 20 μm, or greater than or equal to about 14 μm and less than or equal to about 20 μm.

When the small secondary particles have a particle diameter within any of the recited ranges, active mass density of an electrode plate may be increased, and safety of a rechargeable lithium battery may be improved, and when the large secondary particles have a particle diameter within any of the recited ranges, active mass density of a positive electrode plate may be increased, and/or high rate capability may be improved.

In an embodiment, the secondary particles may be the small secondary particles having a particle diameter of greater than or equal to about 5 μm and less than about 8 μm, the large secondary particles having a particle diameter of greater than or equal to about 8 μm and less than or equal to about 20 μm, or a mixture thereof. When the secondary particles are the mixture of the small secondary particles having a particle diameter of greater than or equal to about 5 μm and less than about 8 μm and the large secondary particles having a particle diameter of greater than or equal to about 8 μm and less than or equal to about 20 μm, a mixing weight ratio thereof may be about 10:90 to about 30:70, for example, about 20:80 to about 15:85.

When the secondary particles are present as the mixture of the aforementioned small and large secondary particles, a high-capacity cell may be obtained by overcoming a capacity limit per volume of the positive active material and maintaining excellent active mass density of the positive electrode plate. The active mass density of the positive electrode plate may be, for example about 3.9 g/cm³ to about 4.1 g/cm³. This active mass density of the positive electrode plate is higher than about 3.3 g/cm³ to about 3.5 g/cm³ of active mass density of the electrode plate including a commercially-available nickel-based lithium metal oxide and accordingly, may increase capacity per volume.

In an embodiment, a (003) peak may have a full width at half maximum in a range of about 0.120° to about 0.125° in an X-ray diffraction spectrum analysis of the nickel-based lithium metal oxide. In addition, the positive active material may have a (104) peak showing a full width at half maximum of about 0.105° to about 0.110° and a (110) peak showing a full width at half maximum of about 0.110° to about 0.120°. These full widths at half maximum exhibit (reflect) crystallinity of the nickel-based lithium metal oxide.

In one or more embodiments, the nickel-based lithium metal oxide exhibits a full width at half maximum of the (003) peak within a range of about 0.130° to about 0.150° in the X-ray diffraction analysis spectrum. The lower the full width at half maximum is, the higher the crystallinity of the nickel-based lithium metal oxide is. Accordingly, the nickel-based lithium metal oxide according to an embodiment of the present invention exhibits high crystallinity compared with a comparable nickel-based lithium metal oxide in the related art. When the nickel-based lithium metal oxide having higher crystallinity is used as a positive active material, a rechargeable lithium battery securing safety at a high voltage may be manufactured.

In the nickel-based lithium metal oxide, a percentage (cation mixing ratio) of nickel ions occupying a lithium site may be less than or equal to about 1.0 atom %, for example, about 0.0001 atom % to about 0.3 atom %. In a high-temperature firing process, Ni ions (Ni²⁺) having a similar ion radius (e.g., having an ion radius of about 0.83 Å) to that of lithium ions (Li⁺) (e.g., having an ion radius of about 0.90 Å) are mingled into a lithium ion-diffusing surface, and thus tend to be more possibly prepared into a nonstoichiometric composition of [Li₁₋ₓNiₓ]_{3b}[Ni]₃ₐ[O₂]_{6c} (wherein a, b, and c indicate site positions of a structure, and x indicates the number of the Ni ions moving toward the Li site, 0≤x<1). Accordingly, when Ni²⁺ is mixed into the lithium site, the site may be a locally irregularly-aligned rock-salt layer (Fm3m), and thus is not only electrochemically inactive but also hinders the lithium ions of a lithium layer from solid-phase diffusion and thus suppresses or reduces a battery reaction.

The nickel-based lithium metal oxide may have improved battery characteristics by suppressing (or reducing) such cation mixing ratio.

The crystal structure of the positive active material may include a hexagonal crystal structure according to the XRD analysis, and an a-axis may have a length of about 2.867 Å to about 2.889 Å, a c-axis may have a length of about 14.228 Å to about 14.270 Å, and accordingly, a unit lattice (unit cell) volume may be in a range of about 101.35 Å³ to about 102.98 Å³.

The XRD analysis may be performed by using a CuK-alpha ray (X-ray wavelength: about 1.541 Å) as a light source.

The positive active material according to an embodiment may suppress (or reduce) a surface side-reaction of residual lithium with an electrolyte solution by adjusting a mixing weight ratio of lithium relative to a metal and controlling heat-treatment conditions (a heat-treatment temperature, atmosphere, and/or time) during the preparation process of the positive active material, to adjust sizes of the primary particles and/or the secondary particles of the positive active material, thus reducing a specific surface area of the positive active material and substantially removing the residual lithium. As described above, when the manufacturing process may be controlled, crystallinity of the positive active material may be improved, and stability thereof may be secured.

In the positive active material, a content of the residual lithium may be less than or equal to about 0.1 wt %. For example, a content of LiOH may be in a range of about 0.01 wt % to about 0.06 wt %, and a content Li₂CO₃ may be in a range of about 0.05 wt % to about 0.1 wt %. Herein, the contents (e.g., amounts) of LiOH and Li₂CO₃ may be measured utilizing a titration method.

In the positive active material, a content (e.g., amount) of the lithium carbonate (Li₂CO₃), measured through a GC-MS analysis, may be in a range of about 0.01 wt % to about 0.05 wt %.

As described above, when the content of the residual lithium is small, a side-reaction of the residual lithium with an electrolyte solution may be suppressed (or reduced), and gas generation at a high voltage and a high temperature may be suppressed (or reduced), and accordingly, the positive active material may exhibit excellent safety. In addition, when the content of LiOH is small, pH of the positive electrode slurry is decreased during the manufacturing process, and accordingly, the positive electrode slurry may be stable and thus accomplish uniform (or substantially uniform) electrode plate coating. This LiOH decrease may secure slurry stability during the slurry manufacturing process for the positive electrode coating.

The positive active material may exhibit characteristics of a high onset point temperature of about 250° C. to about 270° C. compared with that of a comparable commercially-available nickel-based lithium metal oxide (e.g., NCM) in a differential scanning calorimetry analysis and a decreased instantaneous heat release rate of a main peak. When the positive active material exhibits these characteristics, high temperature safety of a lithium ion rechargeable battery may be realized.

Because the positive active material according to the present embodiments may suppress (or reduce) the side-reaction of the nickel-based lithium metal oxide with an electrolyte solution, thermal stability and structural stability of the nickel-based lithium metal oxide are improved, and thus stability and charge and discharge characteristics of a rechargeable lithium battery including the positive active material may be improved.

Hereinafter, a method of preparing the positive active material according to an embodiment is described.

The method of preparing the positive active material includes:

mixing a first precursor for forming lithium-metal (M) oxide and a second precursor for forming nickel-based lithium metal oxide having a layered crystal structure with a solvent to obtain a precursor composition,

adding a surfactant to the precursor composition,

first heat-treating the resultant precursor composition in a sealed state and drying to produce a positive active material precursor, and

mixing the positive active material precursor with a lithium precursor, followed by second heat-treating to produce the positive active material.

First, the positive active material precursor composition is obtained by mixing the first precursor for forming the lithium-metal (M) oxide and the second precursor for forming the nickel-based lithium metal oxide (having a layered crystal structure) with a solvent. Herein, water and/or suitable alcohols may be used as the solvent, and the alcohol may include ethanol, methanol, isopropanol, and/or the like.

The contents of the first precursor for forming the lithium-metal (M) oxide and the second precursor for forming the nickel-based lithium metal oxide may be suitably or properly adjusted to obtain the positive active material having a desired composition.

Subsequently, the surfactant is added to the precursor composition, first heat-treating is performed in a closed and sealed state, and then the resultant is dried to prepare the positive active material precursor.

The surfactant may be a non-ionic surfactant. The surfactant may include a vinyl-based polymer having a weight average molecular weight (Mw) of about 20,000 to about 50,000, for example about 25,000 to about 45,000. Non-limiting examples of the vinyl-based polymer may include polyvinyl alcohol (PVA), polyvinylpyrrolidone (PVP), and derivatives thereof. As the derivative of polyvinyl alcohol, the hydroxyl group of polyvinyl alcohol may be replaced by an acetyl group, an acetal group, a formyl group, a butyral group, etc. The derivative of polyvinylpyrrolidone may include a vinylpyrrolidone-vinyl acetate copolymer, a vinylpyrrolidone-vinylalcohol copolymer, and/or a vinylpyrrolidone-vinylmelamine copolymer, without limitation.

The first heat-treating may be, for example, performed at a temperature of about 150° C. to about 550° C., for example, about 150° C. to about 500° C., about 150° C. to about 450° C., about 150° C. to about 400° C., about 150° C. to about 350° C., about 150° C. to about 300° C., about 150° C. to about 250° C., about 150° C. to about 230° C., about 150° C. to about 200° C., for about 5 hours to 15 hours under a high pressure. By the first heat-treating, dispersion including the positive active material precursor dispersed in the solvent may be obtained.

The dispersion is dried to prepare a positive active material precursor in a powder state. The dispersion may be dried at a temperature in a range of about 50° C. to about 100° C. for about 8 hours to about 12 hours in a vacuum oven.

Before the dispersion is dried, a solvent may be further added to the dispersion and the obtained mixture may be centrifuged in order to remove impurities (referred to as a washing process). Herein the solvent may be water, alcohol (for example, ethanol, methanol, and/or isopropanol), and/or the like. The centrifuging process may be performed at about 5,000 rpm to about 8,000 rpm for about 5 to about 15 minutes. The washing process may be performed twice to ten times.

Subsequently, the prepared positive active material precursor is mixed with the lithium precursor and then, second heat-treated to prepare a positive active material for a rechargeable lithium battery.

For example, when the first precursor for forming the lithium-metal (M) oxide is included in an amount of x mole (0<x≤0.05, 0<x≤0.04, 0<x≤0.03, 0.01<x≤0.05, 0.02<x≤0.05, or 0.02<x≤0.03), an amount of the second precursor for forming the nickel-based lithium metal oxide having the layered crystal structure is (1−x) mole, and an amount of the lithium precursor may be adjusted to have a mixing ratio of about 1.03(1+x) mole.

The second heat-treating may be performed under an oxygen (O₂) atmosphere at a temperature of about 600° C. to about 950° C., for example greater than or equal to about 600° C., greater than or equal to about 610° C., greater than or equal to about 620° C., greater than or equal to about 630° C., greater than or equal to about 640° C., greater than or equal to about 650° C., greater than or equal to about 660° C., greater than or equal to about 670° C., greater than or equal to about 680° C., greater than or equal to about 690° C. or greater than or equal to about 700° C. and less than or equal to about 950° C., less than or equal to about 940° C., less than or equal to about 930° C., less than or equal to about 920° C., less than or equal to about 910° C., less than or equal to about 900° C., less than or equal to about 890° C., less than or equal to about 880° C., less than or equal to about 870° C., less than or equal to about 860° C., or less than or equal to about 850° C., for about 5 hours to about 15 hours. In an embodiment, when a nickel amount is less than or equal to about 70 mol % based on a total amount of metals of the nickel-based lithium metal oxide, the second heat-treating may be performed at greater than or equal to about 700° C., greater than or equal to about 710° C., greater than or equal to about 720° C., greater than or equal to about 730° C., greater than or equal to about 740° C., or greater than or equal to about 750° C. In another embodiment, when the nickel amount is greater than about 70 mol % based on a total amount of the metals of the nickel-based lithium metal oxide, the second heat-treating may be performed at greater than or equal to about 650° C., greater than or equal to about 660° C., greater than or equal to about 670° C., greater than or equal to about 680° C., greater than or equal to about 690° C., or greater than or equal to about 700° C. and less than or equal to about 800° C., less than or equal to about 790° C., less than or equal to about 780° C., less than or equal to about 770° C., less than or equal to about 760° C., or less than or equal to about 750° C.

When the second heat-treating is performed within the ranges described herein, phase-separation of the lithium-metal oxide may easily occur, and the coating layer including the lithium-metal oxide may be stably (or suitably) formed.

During the second heat-treating, a temperature-increasing rate and a cooling rate (e.g., ramp rates) are each independently less than or equal to about 5° C./min, less than or equal to about 4° C./min, less than or equal to about 3° C./min, less than or equal to about 2° C./min, or less than or equal to about 1° C./min. When the second heat-treating is performed within the range described herein, phase-separation of the lithium-metal oxide may easily occur, and the coating layer including the lithium-metal oxide may be stably (or suitably) formed.

The method may further include additional heat-treating after the second heat-treating. The additional heat-treating may further stabilize the structure of the coating layer including lithium-metal oxide.

In the method, the first precursor for forming lithium-metal (M) oxide may include a metal (M)-containing halide, a metal (M)-containing sulfate, a metal (M)-containing hydroxide, a metal (M)-containing nitrate, a metal (M)-containing carboxylate, a metal (M)-containing oxalate, or a combination thereof. Non-limiting examples of the first precursor may include tin chloride (SnCl₂), zirconium chloride (ZrCl₄), tellurium chloride (TeCl₄), ruthenium chloride (RuCl₄), titanium chloride (TiCl₄), manganese chloride (MnCl₄), hafnium chloride (HfCl₄), lead chloride (PbCl₄), tin sulfate (SnSO₄), zirconium sulfate (Zr(SO₄)₂), tellurium sulfate (Te(SO₄)₂), ruthenium sulfate (Ru(SO₄)₂), titanium sulfate (Ti(SO₄)₂), manganese sulfate (Mn(SO₄)₂), hafnium sulfate (Hf(SO₄)₂), lead sulfate (Pb(SO₄)₂), tin hydroxide, zirconium hydroxide, tellurium hydroxide, ruthenium hydroxide, titanium hydroxide, manganese hydroxide, hafnium hydroxide, lead hydroxide, zirconium nitrate, zirconium acetate, zirconium oxalate, tellurium nitrate, tellurium acetate, tellurium oxalate, tellurium chloride, ruthenium nitrate, ruthenium acetate, ruthenium oxalate, titanium nitrate, titanium acetate, titanium oxalate, manganese nitrate, manganese acetate, manganese oxalate, hafnium nitrate, hafnium acetate, hafnium oxalate, and a combination thereof.

The second precursor for forming the nickel-based lithium metal oxide having the layered crystal structure may include, for example, Ni(OH)₂, NiO, NiOOH, NiCO₃.2Ni(OH)₂.4H₂O, NiC₂O₄.2H₂O, Ni(NO₃)₂.6H₂O, NiSO₄, NiSO₄.6H₂O, a nickel fatty acid salt, a nickel halide, or a combination thereof.

The second precursor for forming the nickel-based lithium metal oxide having the layered crystal structure may essentially include a nickel precursor (e.g., as a major component), and may further include one or more metal precursor selected from of a cobalt precursor, a manganese precursor, and an aluminum precursor.

The cobalt precursor may include one or more selected from Co(OH)₂, CoOOH, CoO, Co₂O₃, Co₃O₄, Co(OCOCH₃)₂.4H₂O, CoCl₂, Co(NO)₂.6H₂O, and Co(SO₄)₂.7H₂O.

The manganese precursor may include one or more selected from manganese oxide (such as Mn₂O₃, MnO₂, and/or Mn₃O₄), manganese salts (such as MnCO₃, Mn(NO₃)₂, MnSO₄, manganese acetate, manganese dicarboxylate, manganese citrate, manganese oxy hydroxide, and/or manganese fatty acid salts), and manganese halide (such as manganese chloride).

The aluminum precursor may include aluminum nitrate (Al(NO₃)₃), aluminum hydroxide (Al(OH)₃), aluminum sulfate, and/or the like.

The lithium precursor may include a lithium hydroxide, a lithium nitrate, a lithium carbonate, a lithium acetate, a lithium sulfate, a lithium chloride, a lithium fluoride, or a mixture thereof.

When the prepared positive active material is used, a positive electrode having excellent (or suitable) chemical stability under a high temperature charge and discharge condition, and a rechargeable lithium battery having excellent (or suitable) power output characteristics by using this positive electrode may be manufactured.

Hereinafter, a process of manufacturing a rechargeable lithium battery by using the above positive active material as a positive active material for a rechargeable lithium battery is examined, and herein, a method of manufacturing the rechargeable lithium battery having a positive electrode, a negative electrode, a lithium salt-containing non-aqueous electrolyte, and a separator is illustrated.

The positive electrode and negative electrode are fabricated by coating and drying each of a composition for forming a positive active material layer and a composition for forming a negative active material layer on a current collector, respectively.

The positive active material forming composition is prepared by mixing a positive active material, a conductive agent, a binder, and a solvent. The positive active material according to an embodiment is used as the positive active material for the composition.

The binder may help binding of active materials, conductive agent, and/or the like, and binding them on a current collector, and may be added in an amount of about 1 to about 50 parts by weight based on a total weight (100 parts by weight) of the positive active material. Non-limiting examples of such a binder may be polyvinylidene fluoride, polyvinyl alcohol, carboxymethyl cellulose (CMC), starch, hydroxypropyl cellulose, recycled cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluorine rubber, various copolymers, and the like. The amount thereof may be about 1 part by weight to about 5 parts by weight based on a total weight (100 parts by weight) of the positive active material. When the amount of the binder is within the ranges described herein, the binding force of the active material layer to the current collector is good (or suitable).

The conductive agent is not particularly limited as long as it does not cause an undesirable chemical change of a battery and has conductivity (e.g., electrical conductivity), and may be, for example, graphite (such as natural graphite and/or artificial graphite); a carbon-based material (such as carbon black, acetylene black, ketjen black, channel black, furnace black, lamp black, summer black and/or the like); a conductive fiber (such as a carbon fiber, a metal fiber, and/or the like); carbon fluoride; a metal powder (such as an aluminum and/or nickel powder); zinc oxide, a conductive whisker (such as potassium titanate, and/or the like); a conductive metal oxide (such as a titanium oxide); and/or a conductive material (such as a polyphenylene derivative, and/or the like).

The amount of the conductive agent may be about 1 part by weight to about 5 parts by weight based on a total weight (100 parts by weight) of the positive active material. When the amount of the conductive agent is within the range described herein, conductivity characteristics (e.g., electrical conductivity characteristics) of the resultant electrode are improved.

Non-limiting examples of the solvent may be N-methyl pyrrolidone, and the like.

The amount of the solvent may be about 10 parts by weight to about 200 parts by weight based on 100 parts by weight of the positive active material. When the amount of the solvent is within the range described herein, the work for forming the active material layer may become easy.

The positive current collector may have a thickness of about 3 μm to about 500 μm, is not particularly limited as long as it does not cause an undesirable chemical change in the battery and has high conductivity (e.g., high electrical conductivity), and may be, for example, stainless steel, aluminum, nickel, titanium, heat-treated carbon, aluminum and/or stainless steel of which the surface is treated with carbon, nickel, titanium, and/or silver. The current collector may have fine irregularities formed on a surface thereof to increase adhesive force of the positive active material, and may have various suitable forms such as a film, a sheet, a foil, a net, a porous body, foam, and/or a non-woven fabric body.

Separately, a negative active material, a binder, a conductive agent, and a solvent are mixed to prepare a composition for a negative active material layer.

The negative active material may use a material capable of intercalating and deintercalating lithium ions. Non-limiting examples of the negative active material may be a carbon-based material (such as graphite and/or carbon), a lithium metal, an alloy thereof, a silicon oxide-based material, and the like. According to an embodiment of the present invention, silicon oxide may be used.

The binder may be added in an amount of about 1 part by weight to about 50 parts by weight based on a total weight (100 parts by weight) of the negative active material. Non-limiting examples of the binder may be the same as those for the positive electrode.

The conductive agent may be used in an amount of about 1 part by weight to about 5 parts by weight based on a total weight (100 parts by weight) of the negative active material. When the amount of the conductive agent is within the range described herein, conductivity characteristics of the resultant electrode are improved.

An amount of the solvent may be about 10 part by weight to about 200 parts by weight based on a total weight (100 parts by weight) of the negative active material. When the amount of the solvent is within the range described herein, the work for forming the negative active material layer may become easy.

The conductive agent and the solvent may use the same materials as those used in manufacturing the positive electrode.

The negative current collector may have a thickness of about 3 μm to about 500 μm. Such a negative current collector is not particularly limited as long as it does not cause an undesirable chemical change in the battery and has high conductivity, and may be, for example, copper, stainless steel, aluminum, nickel, titanium, heat-treated carbon, copper, stainless steel of which the surface is treated with carbon, nickel, titanium, silver, an aluminum-cadmium alloy, and/or the like. In addition, the negative current collector may have fine irregularities formed on a surface thereof to increase adhesive force of the negative active materials, and may have various suitable forms such as a film, a sheet, a foil, a net, a porous body, foam, and/or a non-woven fabric body, like the positive current collector.

A separator may be disposed (positioned) between the positive electrode and the negative electrode manufactured according to the above processes.

The separator may have a pore diameter of about 0.01 μm to about 10 μm and a thickness of about 5 μm to about 300 μm. Non-limiting examples may be an olefin-based polymer such as polypropylene, polyethylene, and/or the like; and a sheet and/or a nonwoven fabric formed of a glass fiber. In the case that a solid electrolyte such as a polymer is used as the electrolyte, the solid electrolyte may also serve as the separator.

A lithium salt-containing non-aqueous electrolyte may be composed of a non-aqueous electrolyte and a lithium salt. The non-aqueous electrolyte may be a non-aqueous electrolyte, an organic solid electrolyte, and/or inorganic solid electrolyte.

The non-aqueous electrolyte may be selected from, for example, aprotic organic solvents such as N-methyl-2-pyrrolidinone, propylene carbonate, ethylene carbonate, butylene carbonate, dimethyl carbonate, diethyl carbonate, gamma-butyro lactone, 1,2-dimethoxyethane, 2-methyl tetrahydrofuran, dimethylsulfoxide, 1,3-dioxolane, N,N-formamide, N,N-dimethyl formamide, acetonitrile, nitromethane, methyl formate, methyl acetate, trimethoxymethane, dioxolane derivative, sulfolane, methyl sulfolane, 1,3-dimethyl-2-imidazolidinone, a propylene carbonate derivative, a tetrahydrofuran derivative, ether, methyl propionate, ethyl propionate, and/or the like.

The organic solid electrolyte may be, for example, a polyethylene derivative, a polyethylene oxide derivative, a polypropylene oxide derivative, a phosphoric acid ester polymer, polyvinyl alcohol, polyvinylidene fluoride, and/or the like.

The inorganic solid electrolyte may be, for example, Li₃N, LiI, Li₅NI₂, Li₃N—LiI—LiOH, Li₂SiS₃, Li₄SiO₄, Li₄SiO₄—LiI—LiOH, Li₃PO₄—Li₂S—SiS₂, and/or the like.

The lithium salt may be a material which is readily soluble in the non-aqueous electrolyte, and, for example, may be LiCl, LiBr, LiI, LiClO₄, LiBF₄, LB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, (FSO₂)₂NLi, (FSO₂)₂NLi, lithium chloroborate, lower aliphatic lithium carbonate, tetraphenyl lithium borate, and/or the like.

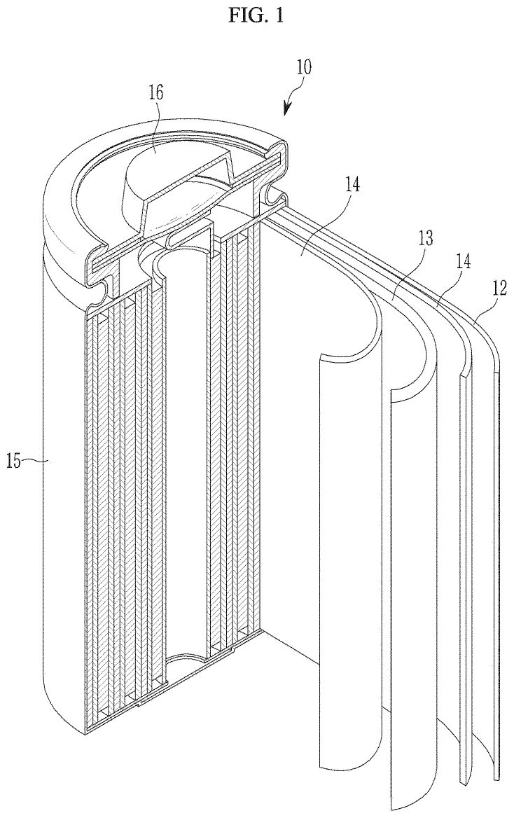

FIG. 1 is a perspective view schematically showing a representative structure of a rechargeable lithium battery according to an embodiment.

Referring to FIG. 1, a rechargeable lithium battery 10 includes a positive electrode 13 including the positive active material, a negative electrode 12, and a separator 14 disposed between the positive electrode 13 and the negative electrode 12, an electrolyte impregnated in the positive electrode 13, negative electrode 12, and separator 14, a battery case 15, and a cap assembly 16 sealing the battery case 15. The lithium secondary battery 10 may be fabricated by sequentially stacking the positive electrode 13, negative electrode 12, and separator 14 and spiral-winding them, and housing the wound product in the battery case 15. The battery case 15 is sealed with the cap assembly 16 to complete the rechargeable lithium battery 10.

The rechargeable lithium battery may be used for a battery cell used as a power source for small devices due to improved power output characteristics, as well as a unit battery in a medium/large battery pack, or a battery module including a plurality of battery cells used as a power source for medium/large devices.

Examples of the medium/large devices may include electric vehicles including electric vehicles (EVs), hybrid electric vehicles (HEVs), plug-in hybrid electric vehicles (PHEVs), and/or the like; electric motorcycle power tools including electric bicycles (E-bikes), electric scooters (E-scooters), and/or the like, but are not limited thereto.

Hereinafter, the embodiments are illustrated in more detail with reference to examples. These examples, however, are not in any sense to be interpreted as limiting the scope of the present disclosure.

### EXAMPLES

### Preparation of Positive Active Material

### Synthesis Example 1

Ni(NO₃)₂.6H₂O, Co(NO₃)₂.6H₂O, Al(NO₃)₃.9H₂O, and SnCl₂ were respectively mixed to a mole ratio of 0.76:0.1425:0.0475:0.05 and then, dissolved in 60 ml of a mixed solvent of water ethanol=1:1 (v/v) to prepare a precursor composition.

0.3 g of polyvinylpyrrolidone (PVP, Mw=29,000 g/mol) as a surfactant was dissolved in the precursor composition, the solution was placed in a 100 ml Teflon-lined autoclave, and the autoclave was sealed.

The completely-sealed autoclave was heat-treated at a temperature of 180° C. in a convection oven for 10 hours to obtain a dispersion including a Ni_{0.80}Co_{0.15}Al_{0.05}]_{0.95}Sn_{0.05}(OH)₂ precursor.

Water and ethanol were added to the dispersion and then, the mixture was centrifuged at 7000 rpm for 10 minutes for washing. The washing was performed by respectively using the water and the ethanol 4 times to obtain a powder.

The washed powder was dried at a temperature of 80° C. for 10 hours in a vacuum oven to obtain [Ni_{0.80}Co_{0.15}Al_{0.05}]_{0.95}Sn_{0.05}(OH)₂ precursor powder.

The [Ni_{0.80}Co_{0.15}Al_{0.05}]_{0.95}Sn_{0.05}(OH)₂ precursor powder was mixed with LiOH.H₂O powder to a mole ratio of 1:1.08.

The temperature was increased up to 750° C., and the mixed powder was fired (second heat-treated) at a temperature of 750° C. for 10 hours under an O₂ atmosphere, and then was cooled to obtain a [Ni_{0.80}Co_{0.15}Al_{0.05}](OH)₂ positive active material that was coated with Li₂SnO₃. Herein, a temperature-increasing rate was set at 5° C./min, and a cooling rate was set at 1° C./min.

The positive active material included secondary particle in which a plurality of primary particles were agglomerated. The particle diameter of the primary particles was 1.2 μm, and the particle diameter (D50) of the secondary particles was 8.59 μm.

### Synthesis Example 2

A Li[Ni_{0.80}Co_{0.15}Al_{0.05}](OH)₂ positive active material was obtained according to substantially the same method as Synthesis Example 1 except that the mixed powder of the [Ni_{0.80}Co_{0.15}Al_{0.05}](OH)₂ precursor powder and the LiOH.H₂O powder was fired at a temperature of 780° C. for 10 hours under an O₂ atmosphere.

The positive active material included secondary particle in which a plurality of primary particles were agglomerated. The particle diameter of the primary particles was 1.3 μm, and the particle diameter (D50) of the secondary particles was 10.58 μm.

### Synthesis Example 3

Ni(NO₃)₂.6H₂O, Co(NO₃)₂.6H₂O, Mn(NO₃)₃.4H₂O, and SnCl₂ were respectively mixed to a mole ratio of 0.76:0.095:0.095:0.05 and then, dissolved in 60 ml of a mixed solvent of waterethanol=1:1 (v/v) to prepare a precursor composition.

In the precursor composition, 0.3 g of polyvinylpyrrolidone (PVP, Mw=29,000 g/mol) as a surfactant was dissolved, the solution was placed in a 100 ml Teflon-lined autoclave, and the autoclave was sealed.

The completely sealed autoclave was first heat-treated at a temperature of 180° C. for 10 hours in a convection oven to obtain dispersion including a [Ni_{0.80}Co_{0.1}Mn_{0.1}]_{0.95}Sn_{0.05}(OH)₂ precursor.

The dispersion was dispersed in water and ethanol and then, centrifuged at 7000 rpm for 10 minutes for washing. The washing was performed by respectively using the water and the ethanol 4 times.

The washed powder was dried at a temperature of 80° C. for 10 hours in a vacuum oven to obtain [Ni_{0.8}Co_{0.1}Mn_{0.1}]_{0.95}Sn_{0.05}(OH)₂ precursor powder.

The [Ni_{0.8}Co_{0.1}Mn_{0.1}]_{0.95}Sn_{0.05}(OH)₂ precursor powder was mixed with LiOH.H₂O powder in a mole ratio of 1:1.08.

A temperature was increased up to 800° C., and the mixed powder was fired (second heat-treated) at a temperature of 800° C. for 10 hours under an O₂ atmosphere, and then was cooled to obtain a Li[Ni_{0.8}Co_{0.1}Mn_{0.1}]O₂ positive active material that was plane-selectively coated with Li₂SnO₃. Herein, a temperature-increasing rate was set at 5° C./min, and a cooling rate was set at 1° C./min.

The positive active material included secondary particle in which a plurality of primary particles were agglomerated. The particle diameter of the primary particles was 900 nm, and the particle diameter (D50) of the secondary particles was 5.19 μm.

### Synthesis Example 4

A Li[Ni_{0.8}Co_{0.1}Mn_{0.1}]O₂ positive active material was obtained according to substantially the same method as Synthesis Example 3 except that the mixed powder of the [Ni_{0.8}Co_{0.1}Mn_{0.1}]_{0.95}Sn_{0.05}(OH)₂ precursor powder and the LiOH.H₂O powder was fired at a temperature of 780° C. for 10 hours under an O₂ atmosphere.

### Synthesis Example 5

A Li[Ni_{0.80}Co_{0.15}Al_{0.05}]O₂ positive active material was obtained according to substantially the same method as Synthesis Example 1 except that 0.6 g of polyvinylpyrrolidone (PVP) was used.

The positive active material included secondary particle in which a plurality of primary particles were agglomerated. The particle diameter of the primary particles was 900 nm, and the particle diameter (D50) of the secondary particles was 5.15 μm.

### Comparative Synthesis Example 1

Ni(NO₃)₂.6H₂O, Co(NO₃)₂.6H₂O, Al(NO₃)₃.9H₂O, and LiNO₃ were respectively mixed to a mole ratio of 1.03:0.80:0.15:0.05 and then, dissolved in an ethanol solvent to prepare a precursor composition.

In the precursor composition, citric acid as a chelating agent was dissolved to a mole ratio of 1:1 with a total amount of cations present in the precursor composition.

The precursor composition was stirred until all the solvents of the precursor composition were removed, obtaining gel.

The obtained gel was fired at a temperature of 300° C. for 5 hours in the air to obtain powder.

A temperature was increased up to 750° C., and the mixed powder was fired at a temperature of 750° C. for 10 hours under an O₂ atmosphere, and then was cooled to obtain a positive active material, Li[Ni_{0.80}Co_{0.15}Al_{0.05}]O₂. Herein, a temperature-increasing rate was set at 5° C./min, and a cooling rate was set at 1° C./min.

The positive active material included secondary particle in which a plurality of primary particles were agglomerated. The particle diameter of the primary particles was 300 nm, and the particle diameter (D50) of the secondary particles was 7.78 μm.

### Comparative Synthesis Example 2

Ni(NO₃)₂.6H₂O, Co(NO₃)₂.6H₂O, and Mn(NO₃)₃.4H₂O were respectively mixed to a mole ratio of 0.8:0.1:0.1 and then, dissolved in 60 ml of a mixed solvent of water:ethanol=1:1 (v/v) to prepare a precursor composition.

In the precursor composition, 0.3 g of polyvinylpyrrolidone (PVP, Mw=29,000 g/mol) as a surfactant was dissolved and then, placed in a 100 ml Teflon-lined autoclave, and the autoclave was sealed.

The completely sealed autoclave was first heat-treated at a temperature of 180° C. for 10 hours in a convection oven to obtain dispersion including a [Ni_{0.8}Co_{0.1}Mn_{0.1}](OH)₂ precursor.

The dispersion was dispersed in water and ethanol and then, centrifuged at 7000 rpm for 10 minutes for washing. The washing was performed by respectively using the water and the ethanol 4 times.

The washed powder was dried at a temperature of 80° C. for 10 hours in a vacuum oven to obtain [Ni_{0.8}Co_{0.1}Mn_{0.1}](OH)₂ precursor powder.

The [Ni_{0.8}Co_{0.1}Mn_{0.1}](OH)₂ precursor powder was mixed with LiOH.H₂O powder in a mole ratio of 1:1.03.

The temperature was increased up to 750° C., and the mixed powder was fired at 750° C. for 10 hours under an O₂ atmosphere, and then was cooled to obtain a single-crystal positive active material, Li[Ni_{0.8}Co_{0.1}Mn_{0.1}]O₂ coated with Li₂SnO₃. Herein, a temperature-increasing rate was set at 5° C./min, and a cooling rate was set at 1° C./min.

The positive active material included secondary particle in which a plurality of primary particles were agglomerated. The particle diameter of the primary particles was 500 nm, and the particle diameter (D50) of the secondary particles was 4.20 μm.

### Comparative Synthesis Example 3

LiNO₃ and tin (IV) ethylhexanoisopropoxide (Sn—(OOC₈H₁₅)₂(OC₃H₇)₂) to a mole ratio of 2:1 were dissolved in 2-propanol (IPA), and Li[Ni_{0.80}Co_{0.15}Al_{0.05}]O₂ according to Comparative Synthesis Example 1 was dispersed in the obtained coating solution and then, stirred at room temperature for about 20 hours to evaporate the solvent and obtain gel. The coating solution was used in an amount so that an amount of Li₂SnO₃ of a coating material might be 5 moles based on 100 moles of Li[Ni_{0.80}Co_{0.15}Al_{0.05}]O₂.

The obtained gel was fired at a temperature of 150° C. for 10 hours to obtain powder.

A temperature was increased up to 700° C., and the obtained powder was fired at a temperature of 700° C. for 5 hours under an O₂ atmosphere, and then was cooled to obtain Li[Ni_{0.80}Co_{0.15}Al_{0.05}]O₂ coated with Li₂SnO₃. Herein, a temperature-increasing rate was set at 10° C./min, and a cooling rate was set at less than or equal to about 1° C./min.

The positive active material included secondary particle in which a plurality of primary particles were agglomerated. The particle diameter of the primary particles was 300 nm, and the particle diameter (D50) of the secondary particles was 8.32 μm.

### Comparative Synthesis Example 4

LiNO₃ and tin (IV) ethylhexanoisopropoxide (Sn—(OOC₈H₁₅)₂(OC₃H₇)₂) to a mole ratio of 2:1 were dissolved in 2-propanol (IPA), and Li[Ni_{0.8}Co_{0.1}Mn_{0.01}]O₂ according to Comparative Synthesis Example 2 was dispersed in the solution and then, stirred for about 20 hours at room temperature to evaporate the solvent and thus obtain gel. The coating solution was used in an amount so that an amount of Li₂SnO₃ of a coating material might be 5 moles based on 100 moles of Li[Ni_{0.8}Co_{0.1}Mn_{0.1}]O₂.

The obtained gel was fired at a temperature of 150° C. for 10 hours to obtain powder.

The temperature was increased up to 700° C., and the obtained powder was fired at a temperature of 700° C. for 5 hours under an O₂ atmosphere, and then was cooled to obtain Li[Ni_{0.8}Co_{0.1}Mn_{0.1}]O₂ coated with Li₂SnO₃. Herein, a temperature-increasing rate was set at 10° C./min, and a cooling rate was set at less than or equal to about 1° C./min.

The positive active material included secondary particle in which a plurality of primary particles were agglomerated. The particle diameter of the primary particles was 500 nm, and the particle diameter (D50) of the secondary particles was 5.33 μm.

### Manufacture of Rechargeable Lithium Battery Cell

### Example 1

The positive active material for a rechargeable lithium battery according to Synthesis Example 1 was used to manufacture a coin cell.

The Li[Ni_{0.80}Co_{0.15}Al_{0.05}]O₂ positive active material according to Synthesis Example 1, Super-p (TIMCAL) as a conductive agent, and polyvinylidene fluoride (PVdF) as a binder were mixed to a mole ratio of 0.80:0.10:0.10, and N-methyl pyrrolidone (NMP) was added thereto and uniformly dispersed therein to prepare a slurry for a positive active material layer.

The prepared slurry was coated on an aluminum foil by using a doctor blade to form a thin electrode plate and then, dried at a temperature of 100° C. for greater than or equal to 3 hours and at a temperature of 120° C. for 10 hours in a vacuum oven to remove moisture and thus manufacture a positive electrode.

The positive electrode and a lithium metal negative electrode were used to manufacture a 2032 type coin cell. Herein, a separator formed of a porous polyethylene (PE) film (a thickness: about 20 μm) was disposed between the positive electrode and the lithium metal counter electrode, and an electrolyte was injected thereinto to manufacture the coin cell.

Herein, the electrolyte was prepared by dissolving 1.3 M LiPF₆ in a mixed solvent of ethylene carbonate (EC), ethylmethyl carbonate (EMC), and dimethyl carbonate (DMC) in a volume ratio of 3:4:3.

### Examples 2 to 5

Rechargeable lithium battery cells according to Examples 2 to 5 were manufactured according to the same (or substantially the same) method as Example 1, except that each positive active material according to Synthesis Examples 2 to 5 was respectively used instead of the positive active material according to Synthesis Example 1.

### Comparative Examples 1 to 4

Rechargeable lithium battery cells according to Comparative Examples 1 to 4 were manufactured according to the same (or substantially the same) method as Example 1, except that each positive active material according to Comparative Synthesis Examples 1 to 4 was respectively used instead of the positive active material according to Synthesis Example 1.

### Evaluation Example 1: XRD Analysis

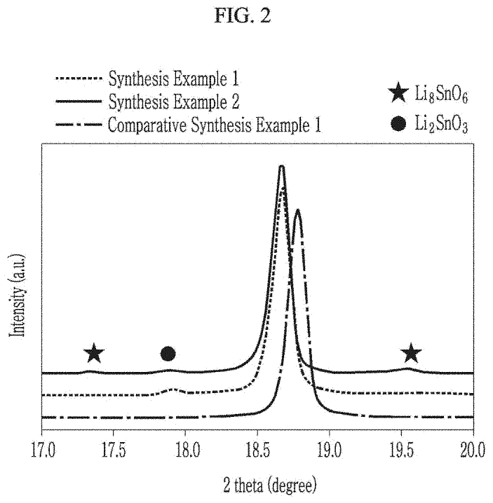

An XRD analysis of each positive active material according to Synthesis Examples 1 and 2 and Comparative Synthesis Example 1 was performed. The XRD analysis was performed by using a Bruker D8 Advance X-ray diffractometer with Cu Kα radiation (λ=1.5406 Å), and the XRD analysis results are shown in FIG. 2.

Referring to FIG. 2, the positive active material according to Synthesis Example 1 exhibited formation of Li₂SnO₃, and the positive active material according to Synthesis Example 2 exhibited formation of Li₂SnO₃ and Li₈SnO₆. On the contrary, the positive active material of Comparative Synthesis Example 1 did not exhibit peaks corresponding to Li₂SnO₃ and Li₈SnO₆. Accordingly, referring to the XRD analysis result of FIG. 2, compositions of the lithium-metal oxide may be adjusted by controlling a firing temperature during the preparation process of the positive active materials.

### Evaluation Example 2: STEM-EDS Analysis

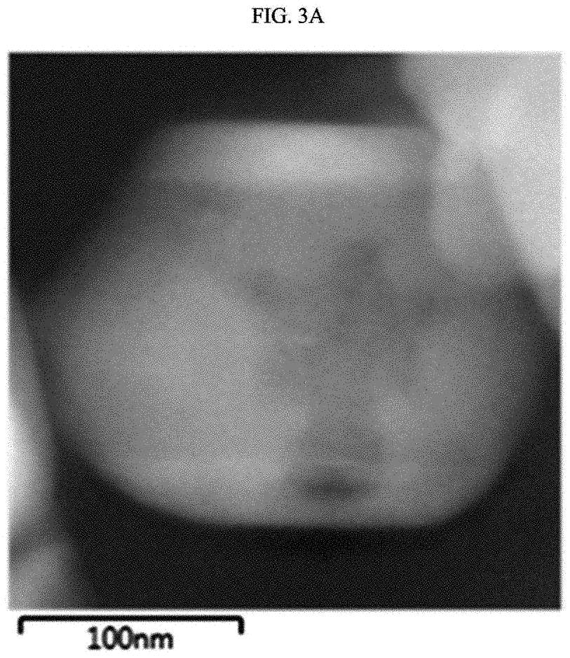

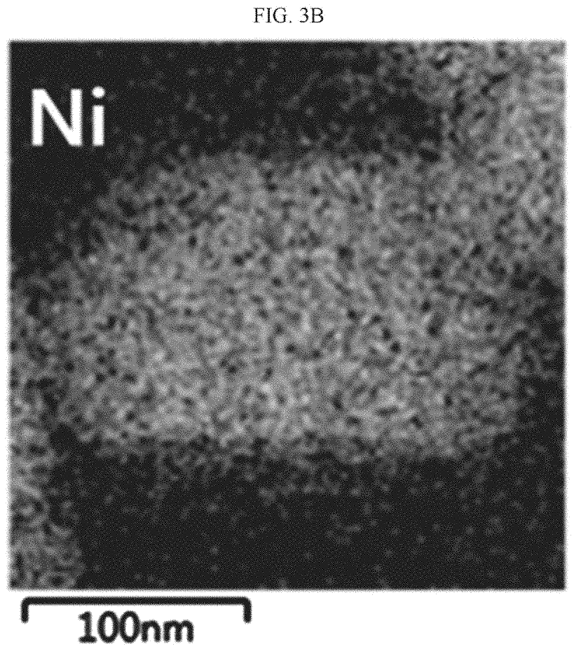

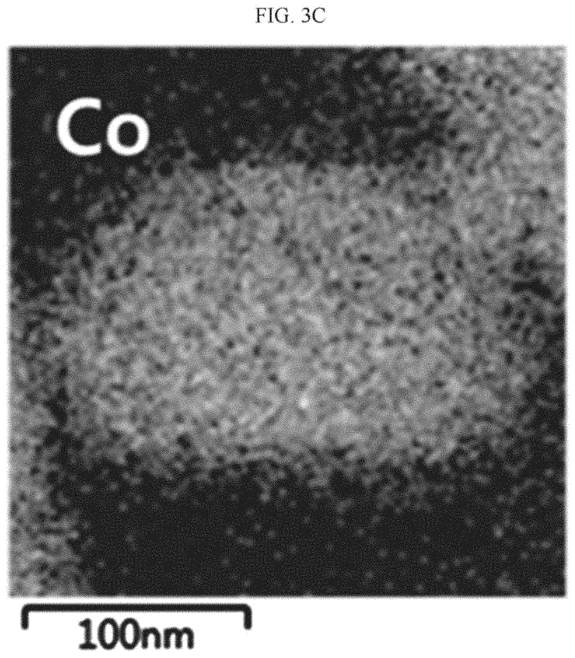

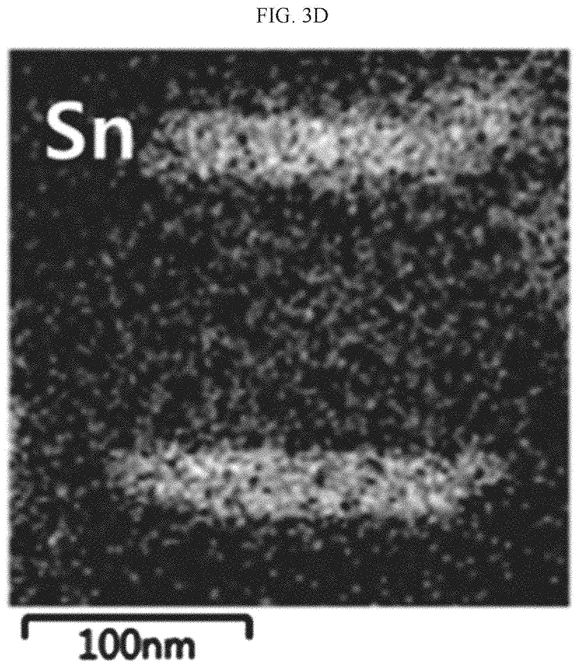

A STEM-EDS (scanning transmission electron microscopy-energy dispersive X-ray spectroscopy) analysis of the positive active material according to Synthesis Example 1 was performed. The STEM-EDS analysis was performed by using a JEM-ARM200F microscope made by JEOL Ltd., and the analysis results are shown in FIGS. 3A to 3D. Specifically, FIG. 3A is a STEM image of the positive active material, and FIGS. 3B, 3C, and 3D are images respectively showing EDS analysis results of Ni, Co, and Sn.

A sample was prepared by cutting the cross section of particles with an Ar ion-slicer to examine a coating formation result with STEM. The results are shown in FIG. 3A.

Referring to FIGS. 3A to 3D, the STEM-EDS analysis result showed that Ni elements and Co elements in a nickel-based lithium metal oxide and Sn elements in a lithium-metal oxide were present in each separate region. Accordingly, Li₂SnO₃ included in a coating layer was coated on a particular plane ([003] plane) of Li[Ni_{0.80}Co_{0.15}Al_{0.05}]O₂, a coated material.

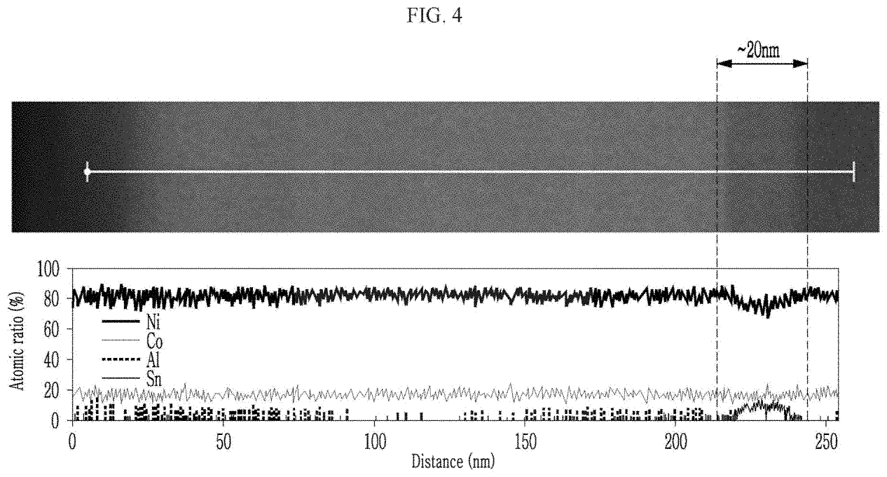

Additionally, an EDS line-profile analysis of Li[Ni_{0.80}Co_{0.15}Al_{0.05}]O₂ plane-selectively coated with Li₂SnO₃ in the c axis direction was performed in order to examine a thickness and a shape of the Li₂SnO₃ coating layer of the positive active material of Synthesis Example 1, and the results are shown in FIG. 4. In FIG. 4, a distance indicates a radius from the surface of the positive active material to the center thereof. In FIG. 4, the distance of 0 nm indicates the surface of the positive active material.

As shown in FIG. 4, as a result of examining the cross section of a particle coated with Li₂SnO₃ through EDS-line profile (line profile), a thickness of the Li₂SnO₃ coating layer was about 20 nm.

### Evaluation Example 3: STEM-HAADF and FFT Analyses

STEM-HAADF (Scanning Transmission Electron Microscope-high-Angle Annular Dark Field) and Fast Fourier Transformation (FFT) analyses of the positive active material according to Synthesis Example 1 were performed. The STEM-HAADF and FFT analyses were performed by using a JEM-ARM200F microscope made by JEOL Ltd.

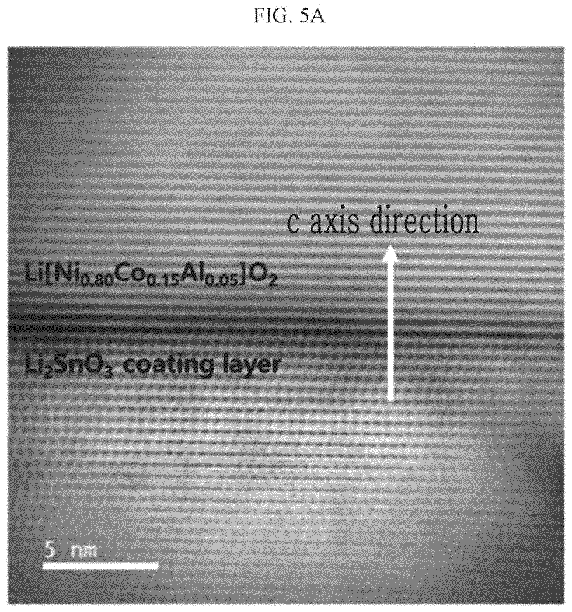

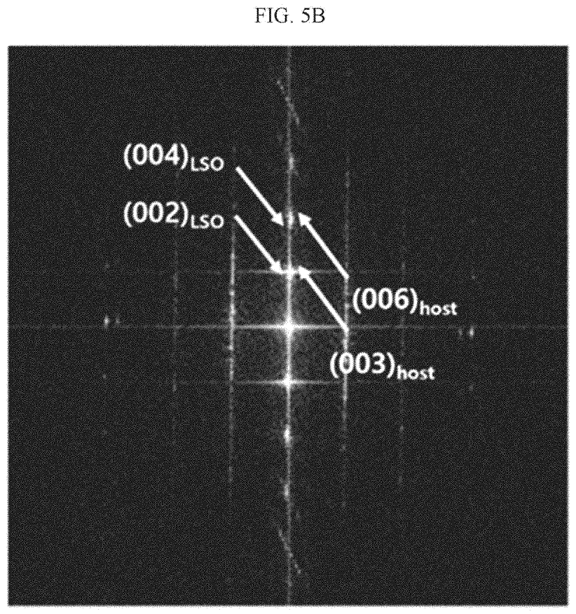

The STEM-HAADF and FFT analysis results were shown in FIGS. 5A and 5B. FIG. 5A is a HAADF image magnified with an atomic resolution with a respect to an interface between Li[Ni_{0.80}Co_{0.15}Al_{0.05}]O₂ and Li₂SnO₃ of the STEM image shown in FIG. 3A, and FIG. 5B shows an FFT pattern of the image.

Referring to FIGS. 5A and 5B, a growth direction of the coating layer was observed. Through the STEM image, as a result of observing an atom alignment and a FFT pattern of Li[Ni_{0.80}Co_{0.15}Al_{0.05}]O₂ and the Li₂SnO₃ coating layer, Li[Ni_{0.80}Co_{0.15}Al_{0.05}]O₂ and the Li₂SnO₃ coating layer all exhibited a layered structure growth in the same c-axis direction. Accordingly, as the (003) crystalline plane of Li[Ni_{0.80}Co_{0.15}Al_{0.05}]O₂, one layered structure, and the 002 plane of Li₂SnO₃ coating layer, another layered structure, were shared with each other, the two materials all epitaxially grew in the c-axis direction.

### Evaluation Example 4: Evaluation of Power Output Characteristics

Power output characteristics of each cell according to Example 1 and Comparative Examples 1 and 3 were evaluated according to the following method.

The coin cells according to Example 1 and Comparative Examples 1 and 3 were charged under a constant current to 4.3 V at a rate of 0.1 C in the 1^{st} cycle and then, discharged under a constant current to 2.7 V at a rate of 0.1 C. The 2^{nd} cycle and the 3^{rd} cycle were repetitively performed under the same condition as the 1^{st} cycle.

The 4^{th} cycle was performed by charging the coin cells under a constant current to 4.3 V at a rate of 0.2 C and discharging them under a constant current to 2.7 V at a rate of 0.2 C after the 3^{rd} cycle. The 5^{th} cycle and the 6^{th} cycle were repetitively performed under the same condition as that of the 4^{th} cycle.

The 7^{th} cycle was performed by charging the coin cells under a constant current to 4.3 V at 0.5 C and then discharging them under a constant current to 2.7 V at a rate of 0.5 C after the 6^{th} cycle. The 8^{th} cycle and the 9^{th} cycle were repetitively performed under the same condition as that of the 7^{th} cycle.

The 10^{th} cycle was performed by charging the coin cells under a constant current to 4.3 V at 1.0 C and then discharging them under a constant current to 2.7 V at a rate of 1.0 C after the 9^{th} cycle. The 11^{th} cycle and the 12^{th} cycle were repetitively performed under the same condition as that of the 10^{th} cycle.

The 13^{th} cycle was performed by charging the coin cells under a constant current to 4.3 V at 2.0 C and then discharging them under a constant current to 2.7 V at a rate of 2.0 C after the 12^{th} cycle. The 14^{th} cycle and the 15^{th} cycle were repetitively performed under the same condition as that of the 13^{th} cycle.

The 16^{th} cycle was performed by charging the coin cells under a constant current to 4.3 V at 5.0 C and then discharging them under a constant current to 2.7 V at a rate of 5.0 C after the 15^{th} cycle. The 17^{th} cycle and the 18^{th} cycle were repetitively performed under the same condition as that of the 16^{th} cycle.

The 19^{th} cycle was performed by charging the coin cells under a constant current to 4.3 V at 7.0 C and then discharging them under a constant current to 2.7 V at a rate of 7.0 C after the 18^{th} cycle. The 20^{th} cycle and the 21^{st} cycle were repetitively performed under the same condition as that of the 19^{th} cycle.

The 22^{nd} cycle was performed by charging the coin cells under a constant current to 4.3 V at 10.0 C and then discharging them under a constant current to 2.7 V at a rate of 10.0 C after the 21^{st} cycle. The 23^{th} cycle and the 24^{th} cycle were repetitively performed under the same condition as that of the 22^{nd} cycle.

Power output characteristics of the coin cells according to Example 1 and Comparative Examples 1 and 3 measured in the above method are shown in Table 2.

TABLE 2

| Capacity | | | |
|---|---|---|---|
| retention | | | |
| relative | | Comparative | Comparative |
| to 0.1 C (%) | Example 1 | Example 1 | Example 3 |
| 1 C | 73.7 | 65.9 | 67.4 |
| 2 C | 61.7 | 51.4 | 51.4 |
| 5 C | 42.3 | 34.1 | 33.1 |
| 7 C | 34.3 | 24.3 | 21.7 |
| 10 C | 22.3 | 8.10 | 8.60 |

Referring to Table 2, the coin cell of Example 1 exhibited improved power output characteristics compared with those of Comparative Examples 1 and 3 within a range of 1 C to 10 C.

The terminology used herein is for the purpose of describing particular example embodiments only and is not intended to limit the example embodiments described herein.

As used herein, the singular forms “a,” “an,” and “the” are intended to include the plural forms as well, unless the context clearly indicates otherwise.

It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, expressions such as “at least one of”, “one of”, and “selected from”, when preceding a list of elements, modify the entire list of elements and do not modify the individual elements of the list.

As used herein, the term “and/or” includes any and all combinations of one or more of the associated listed items.

Further, the use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As used herein, the term “major component” refers to a component that is present in a composition, polymer, or product in an amount greater than an amount of any other single component in the composition or product. In contrast, the term “primary component” refers to a component that makes up at least 50% (wt % or at %) or more of the composition, polymer, or product.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims and their equivalents.

Description of Symbols

| | |
|---|---|
| 10: rechargeable lithium battery | 12: negative electrode |
| 13: positive electrode | 14: separator |
| 15: battery case | 16: cap assembly |

What is claimed is:

1. A positive active material for a rechargeable lithium battery, the positive active material comprising:
a nickel-based lithium metal oxide having a layered crystal structure, and
a coating layer comprising a lithium-metal oxide selectively disposed on (003) crystalline plane of the nickel-based lithium metal oxide,
wherein the positive active material comprises at least one secondary particle comprising an agglomerate of two or more primary particles.

2. The positive active material of claim 1, wherein the lithium-metal oxide has a monoclinic crystal system having a C2/c space group crystal structure.

3. The positive active material of claim 1, wherein a lattice mismatch ratio between a (003) plane of the nickel-based lithium metal oxide and a (00l) plane (wherein l is 1, 2 or 3) of the lithium-metal oxide is less than or equal to about 15%.

4. The positive active material of claim 1, wherein the lithium-metal oxide comprises a compound represented by Chemical Formula 1, a compound represented by Chemical Formula 2, or a combination thereof:
Li₂MO₃ Chemical Formula 1
Li₈MO₆, Chemical Formula 2
wherein, in Chemical Formula 1 and Chemical Formula 2,
M is a metal having an oxidation number of 4.

5. The positive active material of claim 4, wherein the lithium-metal oxide comprises Li₂SnO₃, Li₂ZrO₃, Li₂TeO₃, Li₂RuO₃, Li₂TiO, Li₂MnO₃, Li₂PbO, Li₂HfO₃, Li₈SnO₆, Li₈ZrO₆, Li₈TeO₆, Li₈RuO₆, Li₈TiO₆, Li₈MnO₆, Li₈PbO₆, Li₈HfO₆, or a combination thereof.

6. The positive active material of claim 1, wherein a content of the lithium-metal oxide is about 0.1 mol % to about 5 mol % based on a total amount of the nickel-based lithium metal oxide and the lithium-metal oxide.

7. The positive active material of claim 1, wherein the coating layer has a thickness of about 1 nm to about 100 nm.

8. The positive active material of claim 1, wherein the nickel-based lithium metal oxide and the lithium-metal oxide selectively disposed on the (003) crystalline plane of the nickel-based lithium metal oxide each have a layered structure that is epitaxially grown in a same c-axis direction.

9. The positive active material of claim 1, wherein the nickel-based lithium metal oxide comprises a compound represented by Chemical Formula 3, a compound represented by Chemical Formula 4, or a combination thereof.
LiₐNiₓCo_{y}Q¹_{1-x-y}O₂, Chemical Formula 3
wherein, in Chemical Formula 3,
0.9≤a≤1.05, 0.6≤x≤0.98, 0.01≤y≤0.40, and Q¹ is at least one metal element selected from Mn, Al, Cr, Fe, V, Mg, Nb, Mo, W, Cu, Zn, Ga, In, La, Ce, Sn, Zr, Te, Ru, Ti, Pb, and Hf,
LiₐNiₓQ²₁₋ₓO₂, Chemical Formula 4
wherein, in Chemical Formula 4,
0.9≤a≤1.05, 0.6≤x≤1.0, and Q² is at least one metal element selected from Mn, Al, Cr, Fe, V, Mg, Nb, Mo, W, Cu, Zn, Ga, In, La, Ce, Sn, Zr, Te, Ru, Ti, Pb, and Hf.

10. The positive active material of claim 1, wherein:
the primary particles each independently have a particle diameter of about 100 nm to about 5 μm, and
the secondary particle comprises at least one selected from a small particle diameter secondary particle, having a particle diameter of greater than or equal to about 5 μm and less than about 8 μm, and a large particle diameter secondary particle, having a particle diameter of greater than or equal to about 8 μm and less than or equal to about 20 μm.

11. The positive active material according to claim 10, wherein
the primary particles have a particle diameter of about 500 nm to about 3 μm.

12. The positive active material according to claim 10, wherein
the secondary particle includes at least one of a small particle diameter secondary particle having a particle diameter of greater than or equal to about 5 μm and less than about 6 μm and a large particle diameter secondary particle having a particle diameter of greater than or equal to about 10 μm and less than or equal to about 20 μm.

13. A method of preparing a positive active material for a rechargeable lithium battery, the method comprising:
mixing a first precursor for forming lithium-metal (M) oxide and a second precursor for forming nickel-based lithium metal oxide having a layered crystal structure with a solvent to obtain a precursor composition,
adding a surfactant to the precursor composition,
first heat-treating the resultant precursor composition in a sealed state, and drying to produce a positive active material precursor, and
mixing the positive active material precursor with a lithium precursor, followed by second heat-treating to produce the positive active material of claim 1.

14. The method of claim 13, wherein the first heat-treating is performed at a temperature in a range of about 150° C. to about 550° C.

15. The method of claim 13, wherein the second heat-treating is performed at a temperature in a range of about 600° C. to about 950° C.

16. The method of claim 13, wherein the second heat-treating is performed at a temperature-increasing rate of less than or equal to about 5° C./min.

17. The method of claim 13, wherein the method further comprises cooling after the second heat-treating, and
the cooling is performed at a cooling rate of less than or equal to about 1° C./min.

18. The method of claim 13, wherein the method further comprises additional heat-treating after the second heat-treating.

19. The method of claim 13, wherein the first precursor comprises a metal (M)-containing halide, a metal (M)-containing sulfate, a metal (M)-containing hydroxide, a metal (M)-containing nitrate, a metal (M)-containing carboxylate, a metal (M)-containing oxalate, or a combination thereof.

20. The method of claim 13, wherein the second precursor comprises at least one nickel precursor selected from Ni(OH)₂, NiO, NiOOH, NiC₃.2Ni(OH)₂.4H₂O, NiC₂O₄.2H₂O, Ni(NO₃)₂.6H₂O, NiSO₄, NiSO₄.6H₂O, a nickel fatty acid salt, and a nickel halide.

21. The method of claim 13, wherein the lithium precursor comprises a lithium hydroxide, a lithium nitrate, a lithium carbonate, a lithium acetate, a lithium sulfate, a lithium chloride, a lithium fluoride, or a mixture thereof.

22. A rechargeable lithium battery comprising the positive active material of claim 1.
